(19) United States
(12) Patent Application Publication
(10) Pub. No.: US 2016/0020601 A1
(43) Pub. Date: Jan. 21, 2016

(54) POWER BAY PROTECTION DEVICE AND A METHOD FOR PORTECTING POWER BAYS

(71) Applicant: Rajasekaran VIJAYAGANESH, BANGALORE (IN)

(72) Inventor: Rajasekaran VIJAYAGANESH, BANGALORE (IN)

(73) Assignee: Siemens Aktiengesellschaft, Muenchen (DE)

(21) Appl. No.: 14/412,759

(22) PCT Filed: Jul. 5, 2012
(86) PCT No.: PCT/EP2012/063111

§ 371 Date: Apr. 20, 2015

(51) Int. Cl. H02H 7/22

(52) U.S. Cl. CPC H02H 7/22

(57) ABSTRACT

A power bay protection device which receives a fuse input based on a condition of a fuse for a power bay management device and an undercurrent input related to an undercurrent for one of power lines of the power bay, processes the fuse input based on fuse condition and the undercurrent input and detects a broken conductor in another power bay.

A power bay protection device and a method for protecting power bays

The invention relates to protecting power bays. The invention specifically relates to managing impedance protection within power bays of a power bay system.

Impedance protection often referred to as distance protection is used to protect the transmission line or the feeder in a substation. Such distance protection generally has functionalities like switch onto fault, Power swing detection, Fuse failure, Broken conductor, Carried aided tripping, fault locator, Auto reclosure, Pole discordance etc. The basic protection philosophy of any protection scheme is that it has to operate for a fault within its protection zone and it should be absolutely stable for a fault outside its protected zone.

In some scenarios the distance protection scheme can go for a mal-operation, i.e., distance protection scheme gets activated for no fault condition. One of such scenario is fuse failure occurrence in one bay with the broken conductor occurrence in another bay. If the broken conductor fault occurs in another bay, it creates an unbalance current. If the unbalance current goes more than a threshold, then fuse failure algorithm resets immediately. The impedance protection gets unblocked. Since the measured voltage is zero in that phase where fuse is failed, measured impedance by the impedance protection will also be zero. Here the impedance protection sees fault as close in fault in the conductor and it issues trip to the circuit breaker. This operation of distance protection scheme is referred here as mal-operation. Hence for no fault condition distance protection scheme will unnecessarily trip that line. If this is an important feeder which feeds various utilities like industries, commercial and Transportation etc., it creates interrupted power supply and results in huge loss for the utilities.

It is an object of the invention to manage the power bay in no fault condition case.

The object is achieved by a power bay protection device of claim 1 and a method to manage power bays within a power bay system according to claim 5.

According to an embodiment of the power bay protection device, the device receives fuse input based on a condition of a fuse for a power bay management device and an undercurrent input related to an undercurrent for one of power lines of the power bay. The power bay protection device processes the fuse input and the undercurrent input and detects a broken conductor in another power bay. On a basis of detection of a broken conductor in another power bay, the power bay protection device generates an instruction for blocking an implementation of impedance protection of the power bay by the power bay management device. This reduces the manual intervention and automatically blocks the implementation of impedance protection of the power bay.

According to another embodiment of the power bay protection device, wherein the instruction for blocking an implement tion of impedance protection of the power bay is a binary value. The power bay protection device also includes a trigger module which receives the fuse input based on fuse condition for the power bay management device and generates a trigger. The power bay protection device uses the trigger and the undercurrent input related to undercurrent and detects a broken conductor in another power bay. This makes implementation of blocking of the impedance protection simpler.

According to yet another embodiment of the power bay protection device, the power bay protection device receives a first input based on a unbalanced voltage in each of the power lines in the bay and a second input based on a unbalanced current flowing in each of the power lines in the bay, processes the first input and the second input and generates the fuse input based on a condition of a fuse for a power bay management device, if the first input is about presence of unbalanced voltage and the second input is about absence of unbalanced current. This provides for a bi-directional coupling between the power bay management device and the power bay protection device and reduces human intervention while detecting the broken conductor in another power bay.

The present invention is further described hereinafter with reference to illustrated embodiments shown in the accompanying drawings. The illustrated embodiments of the devices and the methods are intended to illustrate, but not limit the invention. The drawings contain the following figures in which:

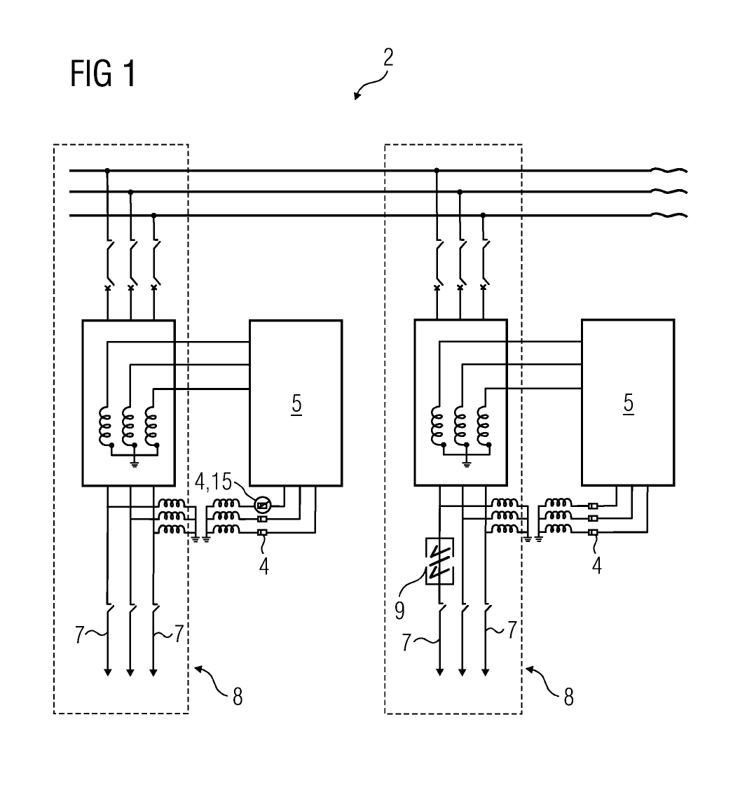

FIG. 1 schematically illustrates occurrence of a mal-operation condition in a power bay system;

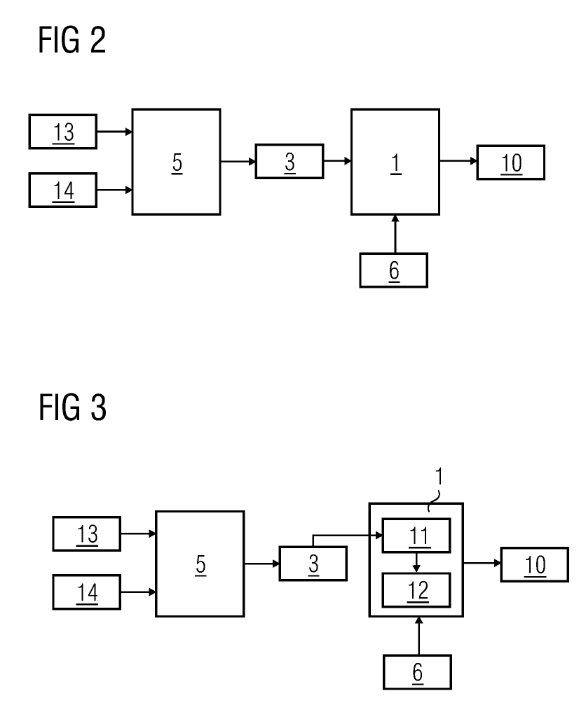

FIG. 2 schematically illustrates the power bay protection device coupled to a power bay management device;

FIG. 3 schematically illustrates the power bay protection device using a trigger, and the power bay protection device coupled to the power bay management device;

Prior to explaining functioning of system through various embodiments, some of the terminology used herein will be explained.

“Power bay system” is a power station having various power bays connected through bus bars. These power substations are used as feeders to other substations or to the end users via power transmission mechanism.

“Power bay” is a part of the power bay system connected to other power bays through bus bars.

“Power line” is conductors carrying power in a power bay.

“Fuse” is a mechanism through which excessive flow of current is managed in a power bay. The fuse is connected between the volatage transformer secondary side and the Power bay protection device, so that whenever abnormal current is flowing, the fuse is blown off and fuse failure mechanism is activated in the power bay management device.

“Fuse failure” refers to a condition regarding blowing out of a fuse in a voltage transformer secondary circuit coupled to the power bay management device, certain measuring loops which measures voltage in a power bay may mistakenly identify voltage of zero, and which due to load current may result in an unwanted trip. Hence the impedance protection needs to be blocked whenever there is a fuse failure. Fuse failure is generally monitored by the presence of unbalance voltage and absence of unbalance current. If these two conditions get satisfied, the impedance protection is blocked and an alarm is issued to the operator that the fuse failure is detected. The fuse failure detection can work either based on zero sequence or negative sequence. It depends on the type of network solidly grounded or high impedance grounded. For solidly grounded system zero sequence will be used and for high impedance grounded system negative sequence will be used.

“Fuse input” can be a value, or a variable, a electrical signal or a mechanical signal or a combination or any other kind of input which is based on condition of fuse for a power bay management device.

“Broken conductor” refers to a fault in the power line of any of the bay in the power bay system. These faults will not cause an increase in phase current and hence cannot be detected by a normal overcurrent function. However they produce an unbalance current which will be monitored by this algorithm and it issues an alarm to the operator that broken conductor is detected.

“Power bay management device”, “Power bay protection device” and “Triggering module” are generally processors which are logic circuitry that responds to and processes the basic instructions for performing a function. They may be a central processing unit of a personal computer adapted to perform the function or microprocessors which are multipurpose, programmable devices that accepts digital data as input, processes it according to instructions stored in its memory, and provides results as output or any other computing device adapted to perform functions of the power bay management device and/or the power bay protection device and/or triggering module according to current invention. However, technical difference between the power bay management device, the power bay protection device and the triggering module are explained through there functionalities while explaining the figures.

“Undercurrent” Current value below the nominal or rated value.

“Unbalanced current”, “Unbalanced voltage”—A three-phase power system is called balanced or symmetrical if the three-phase voltages and currents have the same amplitude and are phase shifted by 120° with respect to each other. If either or both of these conditions are not met, then system is called unbalanced or asymmetrical.

“Instruction for blocking an implementation of impedance protection” can be a value, or a variable, a electrical signal or a mechanical signal or a combination thereof or any other kind of input which will be generated by the power bay protection device for blocking an implementation of impedance protection.

“Trigger” can be electronic information which is indicative of binary actions or a binary value or a combination thereof which is generated by the triggering module by using the fuse input.

“Undercurrent input” can be a value, or a variable, an electrical signal or a mechanical signal or a combination thereof relating to the undercurrent flowing through the power bay.

“First input” can be a value, or a variable, an electrical signal or a mechanical signal or a combination thereof based on a unbalanced voltage in each of the power lines in the bay

“Second input” can be a value, or a variable, an electrical signal or a mechanical signal or a combination thereof based on a unbalanced current flowing in each of the power lines in the power bay.

Initially, to understand the reasons for occurring of mal-operation conditions, the schematic illustration of power bay system is shown in FIG. 1.

In the FIG. 1, a power bay system 2 is shown where various power bays 8 are connected with single busbar arrangement. In one of the power bay 8 amongst 3 fuses 4, one of the fuses 4, 15 is blown out. There will be presence of an unbalance voltage and absence of an unbalance current. Fuse failure algorithm will immediately block the distance protection mechanism in a power bay management device 5 of the power bay 8 where the fuse 4, 15 is blown out. The power bay management device 5 generates an alarm to an operator. Until the operator attends the fuse failure and replaces the fuse 4, 15, the distance protection mechanism will be kept on applying to the power bay management device 5.

If another fault occurs before the operator replaces the fuse 4, 15, suddenly there will be rise in current and an unbalance current gets created and if it goes more than a threshold setting then again fuse failure gets detected automatically and the distance protection mechanism of the power bay management device 5 go for tripping.

Depicting the above mentioned situation in FIG. 1, where operator is yet to replace the fuse 4, 15 (i.e., this power line 7 measures zero voltage) suddenly a broken conductor 9 occurs in any of the other power bay 8 which creates an unbalance current. If the unbalance current goes more than the threshold setting, then fuse failure condition gets reset which unblocks the impedance protection. Since the measured voltage is zero in the power line 7 where fuse 4, 15 is failed, measured impedance will also be zero. Here the impedance protection sees fault as close in fault in the conductor and it issues trip to the circuit breaker. This operation of distance protection scheme is referred here as mal-operation.

Hence for no fault condition distance protection of the power bay management device 5 will unnecessarily trip the power line 7. If this power bay system 2 is an important feeder which feeds various utilities like industries, commercial and Transportation etc., it creates interrupted power supply and results in huge loss for the utilities. Therefore mal-operation of the impedance scheme during above mentioned scenario should be prevented by means of some algorithm. The algorithm is explained in detail below.

While discussing 2 and 3 references will be made to FIG. 1.

FIG. 2 illustrates a schematic diagram of a coupling between the power bay management device 5 and a power bay protection device 1.

The power bay management device 5 receives a first input 13 based on a unbalanced voltage in each of the power lines 7 in the bay 8 and a second input 14 based on a unbalanced current flowing in each of power lines 7 in the bay 8, further processes the first input 13 and the second input 14 and generates a fuse input 3 based on a condition of the fuse 4, if the first input 13 is about presence of unbalanced voltage and the second input 14 is about absence of unbalanced current.

The power bay protection device 1 receives the fuse input 3 based on the condition of the fuse 4 from a power bay management device 5 and an undercurrent input 6 related to an undercurrent for one of power lines 7 of the power bay 8, processes the fuse input 3 based on fuse condition and the undercurrent input 6 to detect a broken conductor 9 in another power bay 8. Alternatively, the power bay protection device 1 need not receive the fuse input 3 based on the condition of the fuse 4 from a power bay management device 5, rather the fuse input information 3 can be manually fed by the operator into the power bay protection device 1.

On a basis of detection of the broken conductor 9 in another power bay 8, the power bay protection device 1 further generates an instruction 10 for blocking an implementation of impedance protection of the power bay 8 by the power bay management device 5. Alternatively, the power bay protection device 1 need not generate the instruction 10 for blocking an implementation of impedance protection of the power bay 8, rather the power bay protection device 1 only detects of the broken conductor 9 in another power bay 8 and alarms the operator who further triggering the blocking of an implementation of impedance protection of the power bay 8 by the power bay management device 5.

The power bay protection device 1 is coupled to the power bay management device 5 through an electrical coupling and/or data coupling, wherein the coupling is through external electrical and data connection. The external data connection includes the wireless data connections like Wi-Fi, Bluetooth, etc. In an alternate embodiment, the power bay protection device 1 can be a sub-part of the power bay management device 1 and the coupling through internal electrical connections and/or internal data connection, wherein the internal connections means the data and/or electrical connections within various modules of the power bay management device 5 and one of such module is the power bay protection device 1.

FIG. 3 illustrates another embodiment of the coupling of between the power bay management device 5 and the power bay protection device 1. For convenience, only aspects which are in addition to the coupling of between the power bay management device 5 and the power bay protection device 1 of FIG. 2, is explained here. In the embodiment of FIG. 3, the power bay protection device 1 further includes a trigger module 11 which receives the fuse input 3 based on fuse condition of the fuse 4 and generates a trigger 12. The power bay protection device 1 uses the trigger 12 and the undercurrent input 6 to identify detection of a broken conductor 9 in another power bay 8. The power bay protection device 1 generates the information 10 for blocking the implementation of impedance protection of the power bay 8 is a binary value.

While this invention has been described in detail with reference to certain embodiments, it should be appreciated that the present invention is not limited to those precise embodiments. Rather, in view of the present disclosure which describes the current best mode for practicing the invention, many modifications and variations would present themselves, to those of skilled in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1-8. (canceled)

9. A power bay protection device for a power bay with power lines and a power bay management device, the power bay protection device comprising:
a fuse input for receiving a fuse input based on a condition of a fuse for a power bay management device;
an undercurrent input for receiving an undercurrent input related to an undercurrent for one of the power lines of the power bay;
a processor to process the fuse input based on fuse condition and the undercurrent input to detect a broken conductor in another power bay.

10. The device according to claim 9, wherein, on a basis of a detection of the broken conductor in another power bay, the power bay protection device is further adapted to generate an instruction for blocking an implementation of impedance protection of the power bay by said power bay management device.

11. The device according to claim 10, wherein the instruction for blocking the implementation of impedance protection of the power bay is a binary value, and the power bay protection device further comprising:
a trigger module adapted to receive the fuse input based on fuse condition for the power bay management device and to generate a trigger signal;
the power bay protection device being adapted to use the trigger signal and the undercurrent input to detect a broken conductor in another power bay.

12. The device according to claim 9, wherein said power bay management device is adapted to:
receive a first input based on an unbalanced voltage in each of the power lines in the power bay and a second input based on an unbalanced current flowing in each of the power lines in the power bay;
process the first input and the second input and generate the fuse input based on a condition of a fuse, if the first input represents a presence of an unbalanced voltage and the second input represents an absence of an unbalanced current.

13. A method for protecting power bays, the power bays having a plurality of power lines, the method comprising:
receiving, by a power bay protection device, a fuse input based on a condition of a fuse for a power bay management device and an undercurrent input related to an undercurrent for one of the power lines of the power bay; and
processing the fuse input and the undercurrent input and detecting a broken conductor in another power bay by the power bay protection device.

14. The method according to claim 13, further comprising:
upon detection of the broken conductor in another power bay, generating an instruction by the power bay protection device for blocking an implementation of impedance protection of the power bay by the power bay management device.

15. The method according to claim 14, wherein the instruction for blocking an implementation of impedance protection of the power bay is a binary value, the method further comprising :
receiving the fuse input based on fuse condition for the power bay management device of the power bay protection device and generating a trigger by a trigger module;
using the trigger and the input for detecting a broken conductor in another power bay by the power bay protection device.

16. The method according to claim 13, comprising:
receiving a first input based on a unbalanced voltage in each of the power lines in the bay and a second input based on a unbalanced current flowing in each of the power lines in the bay by the power bay management device; and
processing the first input and the second input and generating the fuse input by the power bay management device, if the first input represents a presence of an unbalanced voltage and the second input represents an absence of an unbalanced current.
